(19) United States
(12) Patent Application Publication
(10) Pub. No.: US 2009/0258632 A1
(43) Pub. Date: Oct. 15, 2009

(54) SYSTEM AND METHOD FOR DELIVERING AND ENHANCING MESSAGES IN A WIRELESS COMMUNICATION NETWORK

(76) Inventor: Zhibin SUN, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/492,414

(22) Filed: Jun. 26, 2009

Related U.S. Application Data
(63) Continuation of application No. PCT/CN2007/070895, filed on Oct. 15, 2007.

(30) Foreign Application Priority Data
Dec. 31, 2006 (CN) 200610063751.3

(51) Int. Cl. H04L 12/58; H04W 4/12

(52) U.S. Cl. 455/412.1; 455/466

(57) ABSTRACT

A system for delivering and enhancing messages in a wireless communication system includes a message service center and a message enhancing subsystem. The message enhancing subsystem adds information to an acknowledgement message forwarded by the message service center to create an enhanced acknowledgement message and sends the enhanced acknowledgement message to a message sending apparatus. A method for delivering and enhancing messages in a wireless communication system is also disclosed. With the system and method disclosed by the present invention, information may be added to an acknowledgement message so that the content of the acknowledgement message may be richer and the utilization of acknowledgement messages may be more efficient.

This application is a continuation of International Application No. PCT/CN2007/070895, filed Oct. 15, 2007, which claims a priority from the Chinese Patent Application No. 200610063751.3, filed with the Chinese Patent Office on Dec. 31, 2006 and entitled “System and Method for Delivering and Enhancing Messages in Wireless Communication Network”, the contents of both of which are incorporated herein by reference in their entirety.

### TECHNICAL FIELD

The present disclosure relates to wireless communication technologies, and in particular, to a system and method for enhancing messages and delivering the enhanced messages between wireless terminals.

### BACKGROUND

The message delivery acknowledgement and read acknowledgement is a basic function of a messaging service. With this function, a message sender knows the reception and reading of a message in time. As shown in FIG. 1, the process of implementing delivery acknowledgement and read acknowledgement in the conventional art includes:

Step 101: A message sender submits a message destined for a message receiver to a message service center, requesting a delivery acknowledgement message and a read acknowledgement message.

Step 102: Upon reception of the message, the message service center instructs the message receiver to receive the message and the message receiver retrieves the message from the message service center via signaling exchange.

Step 103: The message service center sends a message delivery acknowledgement message to the message sender.

Step 104: The message receiver reads the message and sends a read acknowledgement message to the message service center.

Step 105: The message service center receives the read acknowledgement message and sends the read acknowledgement message to the message sender, and the message sender receives the acknowledgement message.

When the message receiver fails to retrieve the message due to different reasons, the message service center also sends a failure acknowledgment to the message sender, with the reason of failure.

With the above method, the message sender is able to know whether a message is successfully delivered and whether the message is read so as to have a clear view of the message delivery status. The acknowledgment messages, however, include only delivery and read information. The delivered information is limited. There is still space left for further utilization of acknowledgement messages.

### BRIEF SUMMARY

Embodiments of the present disclosure may provide a system and method for delivering and enhancing messages in a wireless communication system. The system and method may enhance acknowledgement messages and deliver the enhanced messages so that more information is carried in the messages and a new marketing channel is provided for the operator.

According to some embodiments, there is provided a system for delivering and enhancing messages in a wireless communication system including a message service center, adapted to forward an initial message from a message sending apparatus to a message receiving apparatus and send an acknowledgement message according to the initial message to a message enhancing subsystem, and the message enhancing subsystem, adapted to receive the acknowledgement message, add information to the received acknowledgement message to create an enhanced acknowledgement message, and send the enhanced acknowledgement message to the message sending apparatus.

According to some embodiments, there is also provided a method for delivering and enhancing messages in a wireless communication system including receiving an acknowledgement message forwarded by a message service center and adding information to the acknowledgement message to create an enhanced acknowledgement message, where the acknowledgement message is returned by a message receiving apparatus to the message service center upon reception of an initial message forwarded by the message service center; and sending the enhanced acknowledgement message to a message sending apparatus.

With the system and method provided by embodiments of the present disclosure, information may be added to the previous pure acknowledgement message so that information data may be carried in the acknowledgement message for delivery. Thus, more information may be included in a message and the utilization of messages is more efficient.

It is to be understood that both the foregoing general description and the following detailed description are exemplary and explanatory only and are not restrictive of the embodiments disclosed herein.

The accompanying drawings, which are incorporated in and constitute a part of this specification, illustrate some embodiments and together with the description, serve to explain the principles of the embodiments disclosed herein.

### BRIEF DESCRIPTION OF THE DRAWINGS

FIG. 1 is a flowchart of delivering acknowledgment messages.

FIG. 2 shows a system for delivering and enhancing messages according to some embodiments.

FIG. 3 is a flowchart of a method for delivering and enhancing messages when an initial message is delivered successfully, according to some embodiments. and

FIG. 4 is a flowchart of a method for delivering and enhancing messages when an initial message fails to delivered, according to some embodiments.

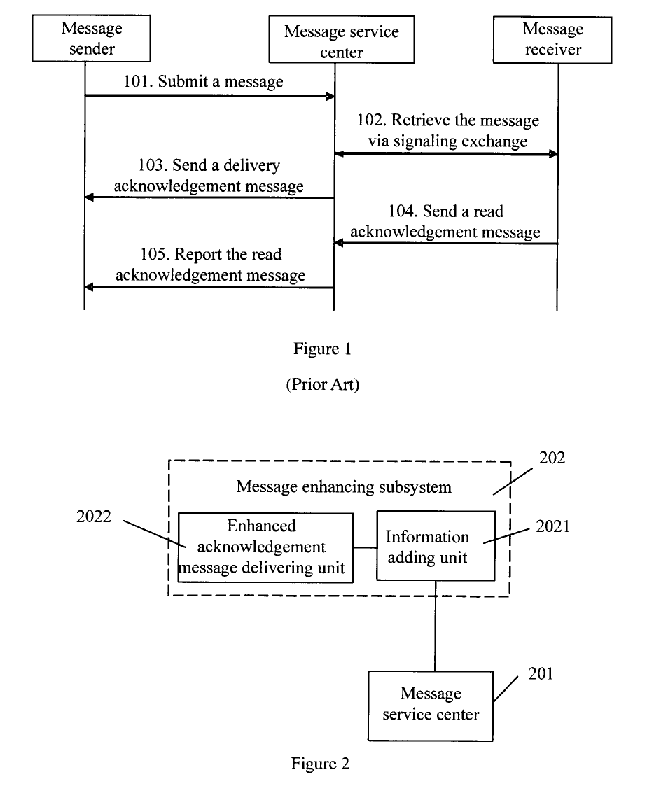

### DETAILED DESCRIPTION OF THE DISCLOSED EMBODIMENTS

The present disclosure is described in detail hereunder with reference to the accompanying drawings and specific embodiments.

As shown in FIG. 2, a system for delivering and enhancing messages according to an embodiment of the present disclosure includes a message service center 201 and a message enhancing subsystem 202.

The message service center 201 may be a short message service center or a multimedia message service center, or an apparatus for delivering other types of messages, and therefore is able to deliver short messages, multimedia messages or other types of messages. When an initial message is delivered, the message service center 201 firstly sets up a wireless connection with a message sending apparatus to receive the initial message from the message sending apparatus. Then the message service center 201 sets up a wireless connection with a message receiving apparatus and sends the initial message to the message receiving apparatus. After the initial message is successfully received and read, the message service center 201 receives a reception acknowledgement message and a message read acknowledgement message from the message receiving apparatus and sets up a connection with an information adding unit 2021 in the message enhancing subsystem 202, and sends a delivery success acknowledgment message and a read acknowledgement message to the information adding unit 2021. When the initial message is delivered unsuccessfully, the message service center 201 sends a delivery failure acknowledgement message to the information adding unit 2021.

The message enhancing subsystem 202 further includes the information adding unit 2021 and an enhanced acknowledgement message delivering unit 2022. The information adding unit 2021 is a service server or another apparatus that may add messages; the enhanced acknowledgement message delivering unit 2022 may be a short message service center, or a multimedia message service center, or another message delivery apparatus and is therefore able to deliver short messages, multimedia messages or other types of messages. The information adding unit 2021 is connected to the enhanced acknowledgment delivering unit 2022. The information adding unit 2021 is connected to the message service center 201 and receives acknowledgement messages from the message service center 201. The information adding unit 2021 adds additional information to an acknowledgment message to create an enhanced acknowledgement message and sends the enhanced acknowledgement message to the enhanced acknowledgement message delivering unit 2022. The enhanced acknowledgment delivering unit 2022 sets up a wireless connection with the message sender and delivers the enhanced acknowledgement message from the information adding unit 2021 to the message sender.

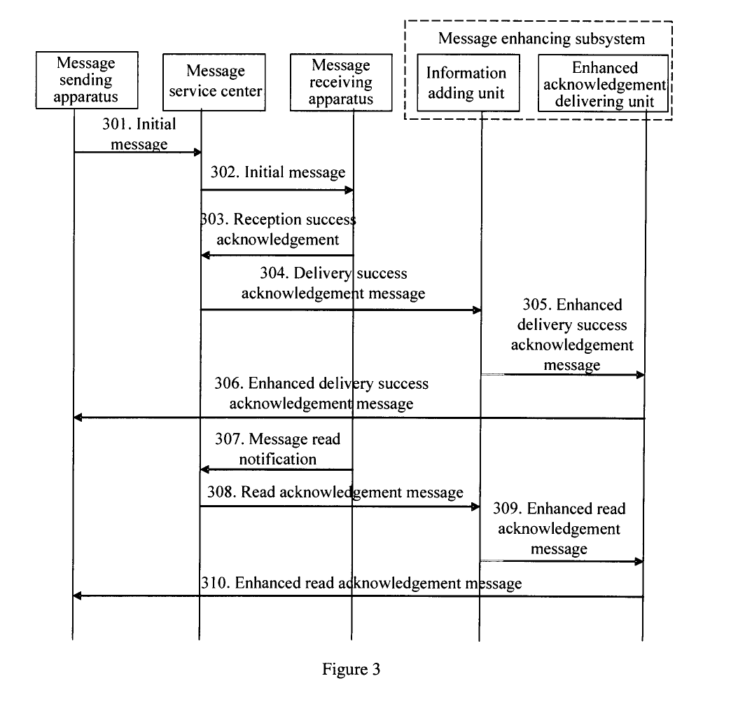

FIG. 3 is a flowchart of a method for delivering and enhancing delivery success acknowledgement messages and read acknowledgement messages when the message receiving apparatus successfully receives and reads an initial message. The method includes:

Step 301: A message service center receives an initial message from a message sending apparatus. The initial message may be a short message or a multimedia message.

Step 302: The message service center forwards the received initial message to a message receiving apparatus and the message receiving apparatus receives the initial message.

Step 303: The message service center receives a reception success acknowledgement message from the message receiving apparatus.

Step 304: The message service center sends a delivery success acknowledgement message to the information adding unit of a message enhancing subsystem. The information adding unit receives the delivery success acknowledgement message, which may be a short message or a multimedia message.

Step 305: The information adding unit adds additional information to the delivery success acknowledgement message to create an enhanced delivery success acknowledgement message. The information adding unit sends the enhanced delivery success acknowledgement message to the enhanced acknowledgement message delivering unit. The enhanced acknowledgement message delivering unit receives the enhanced delivery success acknowledgement message, which may be a short message or a multimedia message.

Step 306: The enhanced acknowledgement message delivering unit forwards the enhanced delivery success acknowledgement message to the message receiving apparatus.

Step 307: The message receiving apparatus reads the initial message and sends a message read notification to the message service center. The message service center receives the notification.

Step 308: After receiving the message read notification, the message service center sends a read acknowledgement message to the information adding unit. The information adding unit receives the read acknowledgement message. The read acknowledgement message may be a short message or a multimedia message.

Step 309: The information adding unit adds additional information to the read acknowledgement message to create an enhanced read acknowledgement message. The information adding unit sends the enhanced read acknowledgement message to the enhanced acknowledgement message delivering unit. The enhanced acknowledgement message delivering unit receives the enhanced read acknowledgement message. The enhanced read acknowledgement message may be a short message or a multimedia message.

Step 310: The enhanced acknowledgement message delivering unit forwards the enhanced read acknowledgement message to the message sending apparatus.

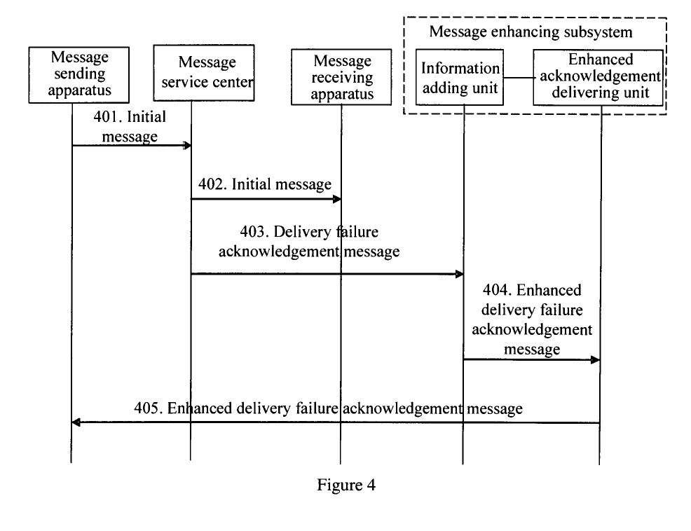

FIG. 4 is a flowchart of a method for delivering and enhancing a delivery failure acknowledgement message when the message receiving apparatus fails to receive an initial message. The method includes:

Step 401: A message service center receives an initial message from a message sending apparatus.

Step 402: The message service center forwards the received initial message to a message receiving apparatus. The message receiving apparatus fails to receive the initial message because of no response or due to other reasons.

Step 403: The message service center sends a delivery failure acknowledgement message to the information adding unit of a message enhancing subsystem. The information adding unit receives the delivery failure acknowledgement message, which may be a short message or a multimedia message.

Step 404: The information adding unit adds additional information to the delivery failure acknowledgement message to create an enhanced delivery failure acknowledgement message. The information adding unit sends the enhanced delivery failure acknowledgement message to the enhanced acknowledgement message delivering unit. The enhanced acknowledgement message delivering unit receives the enhanced delivery failure acknowledgement message, which may be a short message or a multimedia message.

Step 405: The enhanced acknowledgement message delivering unit forwards the enhanced delivery failure acknowledgement message to the message sending apparatus.

Although the present disclosure has been described through some exemplary embodiments, the present disclosure is not limited to such embodiments. It is apparent that those skilled in the art may make various modifications and variations to the present disclosure without departing from the spirit and scope of the present disclosure. The present disclosure is intended to cover the modifications and variations provided that they fall in the scope of protection defined by the following claims or their equivalents.

What is claimed is:

1. A system for delivering and enhancing messages in a wireless communication system, comprising:
a message service center, adapted to forward an initial message from a message sending apparatus to a message receiving apparatus and send an acknowledgement message according to the initial message to a message enhancing subsystem; and
the message enhancing subsystem, adapted to receive the acknowledgement message, add information to the received acknowledgement message to create an enhanced acknowledgement message, and send the enhanced acknowledgement message to the message sending apparatus.

2. The system of claim 1, wherein the message enhancing subsystem comprises an information adding unit and an enhanced acknowledgement message delivering unit, wherein:
the information adding unit is adapted to receive the acknowledgement message from the message service center, add information to the acknowledgement message to create an enhanced acknowledgement message, and send the enhanced acknowledgement message to the enhanced acknowledgement message delivering unit; and
the enhanced acknowledgement message delivering unit is adapted to receive the enhanced acknowledgement message from the information adding unit and send the enhanced acknowledgement message to the message sending apparatus.

3. The system of claim 2, wherein the information adding unit is a service server, and the enhanced acknowledgement message delivering unit is one of a multimedia message service center and a short message service center.

4. The system of claim 1, wherein the message service center is one of a multimedia message service center and a short message service center.

5. The system of claim 1, wherein the acknowledgement message is one of a delivery success acknowledgement message, a delivery failure acknowledgement message, and a read acknowledgement message.

6. The system of claim 1, wherein the acknowledgement message is one of a multimedia message and a short message.

7. The system of claim 1, wherein the initial message is one of a multimedia message and a short message.

8. A method for delivering and enhancing messages in a wireless communication system, comprising:
receiving an acknowledgement message forwarded by a message service center and adding information to the acknowledgement message to create an enhanced acknowledgement message, wherein the acknowledgement message is returned by a message receiving apparatus to the message service center upon reception of an initial message forwarded by the message service center; and
sending the enhanced acknowledgement message to a message sending apparatus.

9. The method of claim 8, wherein the acknowledgement message is one of a delivery success acknowledgement message, a delivery failure acknowledgement message, and a read acknowledgement message.

10. The method of claim 8, wherein the acknowledgement message is one of a multimedia message and a short message.

11. The method of claim 8, wherein the initial message is one of a multimedia message and a short message.

12. A message enhancing subsystem for delivering and enhancing messages in a wireless communication system, comprising:
an information adding unit, adapted to receive the acknowledgement message from the message service center, add information to the acknowledgement message to create an enhanced acknowledgement message, and send the enhanced acknowledgement message to the enhanced acknowledgement message delivering unit; and
the enhanced acknowledgement message delivering unit, adapted to receive the enhanced acknowledgement message from the information adding unit and send the enhanced acknowledgement message to the message sending apparatus.

13. The message enhancing subsystem of claim 12, wherein the information adding unit is a service server, and the enhanced acknowledgement message delivering unit is one of a multimedia message service center and a short message service center.

14. The message enhancing subsystem of claim 12, wherein the acknowledgement message is one of a delivery success acknowledgement message, a delivery failure acknowledgement message, or a read acknowledgement message.

15. The message enhancing subsystem of claim 12, wherein the acknowledgement message is one of a multimedia message and a short message.

16. The message enhancing subsystem of claim 12, wherein the initial message is one of a multimedia message and a short message.
